(19) United States
(12) Patent Application Publication
(10) Pub. No.: US 2024/0152703 A1
(43) Pub. Date: May 9, 2024

(54) CHAT DISCOURSE COMPARISON USING WORD DENSITY FUNCTION

(71) Applicant: INTERNATIONAL BUSINESS MACHINES CORPORATION, ARMONK, NY (US)

(72) Inventors: Qi Li, Beijing (CN); Jin Sheng Gao, Beijing (CN); Jonathan D. Dunne, Dungarvan (IE); Akash Bhargava, Dublin (IE)

(21) Appl. No.: 18/052,730

(22) Filed: Nov. 4, 2022

(51) Int. Cl. G06F 40/35; G06F 16/332; G06F 40/279; H04L 51/02

(52) U.S. Cl. CPC G06F 40/35; G06F 16/3329; G06F 40/279; H04L 51/02

(57) ABSTRACT

A computing device determines similarity between a chat conversation and one or more other chat conversations in public chat channels within computer messaging software and automatically presents the similar public chat channels to a user. A computing device accesses a real-time chat conversation, the chat conversation taking place between a plurality of participants. The computing device analyzes the real-time chat conversation to generate a word density function model modeling at least a part of the real-time chat conversation. The computing device accesses one or more persistent conversations held in a plurality of public chat channels. The computing device determines one or more persistent conversations held in similar public chat channels based upon the generated word density function model. The computing device presents the determined one or more persistent similar public chat channels to a user.

### FIELD OF THE INVENTION

The present invention relates generally to natural language processing and computer messaging software and more particularly to a comparison and presentation of similar chat conversations across chat channels in computer messaging software using a word density function.

### BACKGROUND

The present embodiments relate to computer messaging software. As the nature of work changes and work becomes less a place to go and more flexible in terms of where a person physically works, computer messaging software allowing communications between any number of people from across the room to across the globe is becoming increasingly important. Computer messaging software allows communication in various communication channels between thousands or more of potential participants on any topic of interest, personal or professional, in order to disseminate information, ask questions, respond to questions, make announcements, perform various work functions, etc. Unfortunately, because of the simple volume of information presented in computer messaging software, (such as with computer messaging software used by a global company, or the like), there is the danger of simple information overload, while being unable to locate the information actually needed on a timely basis and without difficulty. With this information overload, information can become particularly difficult to locate in the computer messaging software when required, leading to possible repetitive questions being asked in the computer messaging software, clogging up communication channels, wasting time, and leading to decreased productivity.

A need presents itself for an easy and automatic means to locate relevant information across a plurality of chat channels in a computer messaging system, facilitating users of the computer messaging software quickly and easily locating relevant information.

### SUMMARY

Embodiments of the present invention disclose a method, system, and computer program product using a computing device to determine a similarity between a chat conversation and one or more other chat conversations in public chat channels within computer messaging software and automatically presenting the similar public chat channels to a user. The computing device accesses a real-time chat conversation, the conversation taking place between a plurality of participants. The computing device analyzes the real-time chat conversation to generate a word density function model modeling at least a part of the real-time chat conversation. The computing device accesses one or more persistent conversations held in a plurality of public chat channels accessible by the computing device. The computing device determines one or more persistent conversations held in a similar public chat channels based upon the generated word density function model. The computing device presents the determined one or more persistent similar public chat channels to a user.

### BRIEF DESCRIPTION OF THE DRAWINGS

FIG. 1 represents a networked computer environment 100, in accordance with an embodiment of the present invention.

FIG. 2 is a functional block diagram illustrating an environment 200 for a determination of similarity between a chat conversation and one or more other chat conversations in computer messaging software 210, in accordance with an embodiment of the present invention.

FIG. 3 is a graphical representation of a word density function model 300, in accordance with an embodiment of the present invention.

FIGS. 4A and 4B are a flowchart depicting operational steps that a hardware component of a hardware appliance may execute, in accordance with an embodiment of the invention.

### DETAILED DESCRIPTION

Computer messaging software, allowing communication between a plurality of participants globally across any number of “channels” available in the computer messaging software, with each channel having differing participants or topics is increasingly valued, and relied upon by corporations and individuals in both professional and personal capacities. Unfortunately, because computer messaging software allows communications between so many people globally, information overload becomes a common issue for each user when trying to, for example, find a post or conversation regarding a specific topic. It can become burdensome for users to, for example, locate information from just a few days before, considering the volume of information presented across the different channels of the computer messaging software. For another example, if users of the computer messaging software have asked a question in the past, difficulties involved in locating the question and response across the channels may lead to unnecessary duplication or re-asking of the questions in channels, further leading to unnecessary clutter. Other technical problems arise from unnecessary duplication of data across multiple public chat channels, such as the need to unnecessarily house a large amount of duplicative data (and the associated large amount of computer infrastructure to house this data, etc.).

Embodiments of the invention are directed towards a method, system, and computer program product for an automated determination of similarity between a chat conversation and one or more other chat conversations presented in different chat channels located in computer messaging software. The presently disclosed embodiments may function as an integrated part of computer messaging software, or may execute in one or more independent computing systems.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with an environment 200 for a determination of similarity between a chat conversation and one or more other chat conversations in computer messaging software 210. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

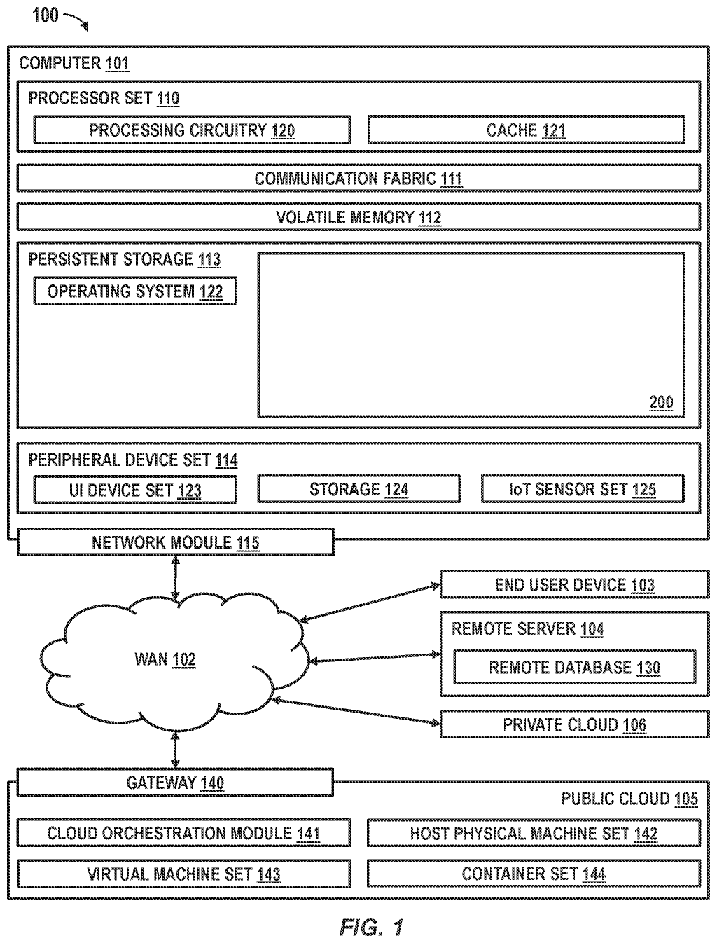

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

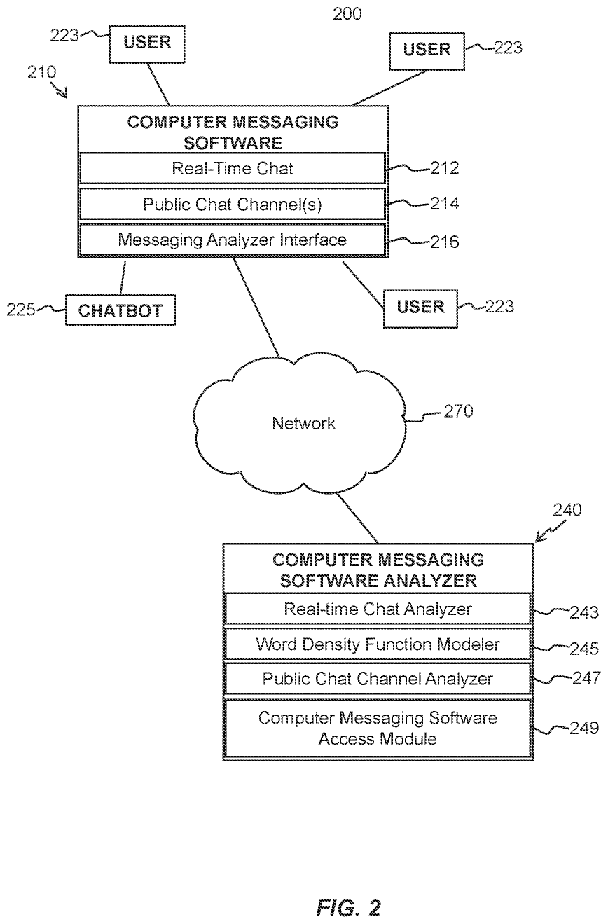

FIG. 2 is a functional block diagram illustrating an environment 200 for a determination of similarity between a chat conversation and one or more other chat conversations in computer messaging software 210, in accordance with an embodiment of the present invention. In an exemplary embodiment as displayed in FIG. 2, computer messaging software 210 is operatively connected to computer messaging software analyzer 240. Computer messaging software 210 may be any sort of computer software (and, in various embodiments, associated computer hardware) allowing for messaging between any number of user(s) 223 (and/or chatbot 225) (user(s) 223 and chatbot 224 also collectively referred to as “participants” herein), with messaging taking the form of any or all of text chat, voice chat, video chat, image chat, braille chat, and/or multimedia chat. As would be understood by one of skill in the art, in embodiments where chatbot 225 is present, chatbot 225 may be an artificial intelligence powered chatbot 225 to, for example, ask and respond to questions from user(s) 223, or provide other information to user(s) 223 in a streamlined, efficient, manner. In various embodiments of the invention, computer messaging software 210 offers persistent chat rooms organized by, for example, topic, division, certain personal, product, etc., as well as offers direct messaging between one or more users 223 of computer messaging software 210, allowing a message to be transmitted between user(s) 223 without being viewed by others. The chat rooms (also referred to herein as “public chat channels”) are “persistent” in that the conversations between users 223 in the chat rooms remain available to users 223 after the conversations end, as well as are accessible in a computer available form by computer messaging software analyzer 240 (such as via natural language processing powered by trained artificial intelligence models). In various embodiments, how the conversations remain “persistent” in computer messaging software 210 may based upon the nature of the conversations: in embodiments where the conversation is in a text chat, the text may simply remain available via scrolling through computer messaging software 210 to prior conversations; in embodiments where the conversation is in voice chat, video chat, and/or multimedia chat, the conversations may be available such as via a recording available in computer messaging software 210, via natural language processing software converting voice to text, via machine learning software automatically creating summaries and/or descriptions of video or multimedia, etc., which are also made available in computer messaging software 210.

Also displayed in FIG. 2, in various embodiments of the invention, is computer messaging software analyzer 240. Computer messaging software analyzer 240, in various embodiments, may be integrated with computer messaging software 210, available across network 270, or otherwise operatively connected to computer messaging software 210). Computer messaging software analyzer 240, in various embodiments of the invention, accesses a real-time chat conversation in computer messaging software 210, analyzes the real-time chat conversation, accesses a plurality of persistent similar public chat channels, and presents (or directs computer messaging software analyzer 240 to present), the similar public chat channel (all steps as further discussed herein).

As further displayed in FIG. 2, in various embodiments of the invention, computer messaging software 210 and computer messaging software analyzer 240 are connected via network 270. In various embodiments, network 270 represents, for example, an internet, a local area network (LAN), a wide area network (WAN) such as the Internet, and includes wired, wireless, or fiber optic connections. In general, network 270 may be any combination of connections and protocols that will support communications between computer messaging software 210 and computer messaging software analyzer 240, in accordance with embodiments of the invention. In further embodiments of the invention, network 270 may represent an internal bus associated with a single or multicore processor executing both computer messaging software 210 and computer messaging software analyzer 240.

Discussing elements displayed in FIG. 2 in further detail, computer messaging software 210 represents computer software (and, in various embodiments, associated computer hardware) to allow for various communications between one or more user(s) 223, chatbot 225, etc., as further discussed herein. In various embodiments, computer messaging software 210 includes one or more of real-time chat 212, public chat channel(s) 214, and/or messaging analyzer interface 216.

Real-time chat 212 represents hardware and/or software allowing for a real-time chat conversation between one or more of user(s) 223 and chatbot 225. Real-time chat 212, in various embodiments of the invention, allows communications between one or more user(s) 223, chatbot 225, etc. in various modalities, including via a voice chat, an audio channel, a video channel, a multimedia channel, etc., or a combination of these modalities. The real-time chat 212 may be via a direct message between user(s) 223, chatbot 225, via a chat channel, or otherwise. The real-time chat 212 allows, for example, for questions to be asked by a user 223 to other user(s) 223 or the chatbot 225, statements to be made by a user 223, requests to be made by one or more user(s) 223, or other communications made in the various modalities. Real-time chat 212 may occur in a direct message between two or more user(s) 223, chatbot 225, or, in further embodiments, real-time chat 212 occurs in a first public chat channel which user(s) 223 and optionally chatbot 225 is a part of. As discussed further below, the real-time chat 212 is analyzed by computer messaging software analyzer 240 to generate a word density function which models at least a part of the real-time chat 212 (or performs another modeling of similarity of the real-time chat 212, as would be understood by one of skill in the art). Real-time chat 212 may be displayed in a scrolling chat window, a static chat window, or any other sort of computer interface accessible by user(s) 223 and chatbot 225.

Public chat channel(s) 214 represents hardware and/or software providing for persistent communications between user(s) 223, chatbot 225, etc. In various embodiments of the invention, public chat channel(s) 214 provide for storage of communications in the form of text, voice (stored in audio files), video (stored in video files), or multimedia communications (stored in appropriate computer files, as understood by one of skill in the art). The stored communications are “persistent” in that previous communications can be accessed by user(s) 223, chatbot 225, as well as computer messaging software analyzer 240. In various embodiments, public chat channel(s) 214 may be available in a graphical user interface which user(s) 223 can scroll though, some other form accessible by user(s) 223 and/or chatbot 225, or as further discussed herein. Conversations in public chat channel(s) 214 may be accessed, for example, from a few weeks or even years before. In a large organization, a number of topics may be available in public chat channel(s) 214, such as questions asked and answers, presentations available, lessons made available, etc. In embodiments of the invention, as discussed further herein, computer messaging software analyzer 240 accesses public chat channel(s) 214 to perform an analysis of available communications to determine similarity to a real-time chat conversation occurring in real-time chat 212. As discussed further herein, this may serve the purpose of avoiding the need to, for example, answer a real-time question presented by user 223 again, or providing duplicative information. Instead, computer messaging software analyzer 240 simply points user 223 to a location in public chat channel(s) 214, or provides some other indication where user 223 can find a similar answer to his or her question in public chat channel(s) 214 (or, in other embodiments, relevant presentations available, relevant training, relevant, lessons, etc., relevant to the real-time chat conversation occurring in real-time chat 212). For example, a user 223 may ask questions of a chatbot 225 regarding a company policy or human resources question. When chatbot 225 is asked a question, rather than generating a short, somewhat ineffectual response, chatbot 225 instead requests that computer messaging software analyzer 240 point to a more thorough, professionally prepared location in public chat channel(s) 214 providing a complete response to the question posed by user 223 in real-time chat 212. The complete response in this hypothetical has been professional prepared by experts in company policy or human resources, and is therefore much more complete and responsive to question asked by user 223.

Messaging analyzer interface 216 represents hardware and/or software facilitating communications between computer messaging software 210 and computer messaging software analyzer 240 across network 270. Messaging analyzer interface 216 provides, in various embodiments, for computer messaging software analyzer 240 to access a real-time chat 212 conversation occurring between one or more user(s) 223 in computer messages software 210 (and, in various embodiments, the real-time chat 212 also including chatbot 225). Messaging analyzer interface 216 also provides computer messaging software analyzer 243 capabilities to access one or more public chat channel(s) 214 in computer messaging software 210. As discussed elsewhere herein, the one or more public chat channel(s) 214 are “persistent” in that text messages, voice messages, video messages, and/or multimedia communications are available after the messages are transmitted. Messaging analyzer interface 216 also provides, in various embodiments, communication capabilities to present to user(s) 223 determined persistent similar public chat channels 214, and automatic direction to the persistent similar public chat channel(s) 214, to, for example, answer the question posed by user(s) 214.

Continuing with regard to FIG. 2, computer messaging software analyzer 240 includes, in various embodiments of the invention, real-time chat analyzer 243, word density function modeler 245, public chat channel analyzer 247, and computer messaging software access module 249.

Real-time chat analyzer 243 represents software and/or hardware for access and analysis of real-time chat 212 in computer messaging software 210. Real-time chat analyzer 243, after accessing the real-time chat 212 (as discussed further herein), in various embodiments of the invention, uses different techniques to analyze real-time chat 243, for purposes as discussed further. The various techniques utilized to analyze the chat include those appropriate for the type of communications occurring in real-time chat 212, whether the communications involve text, voice, video, multimedia, or some combination of these. Natural language processing techniques, for example, may directly be able to interpret a text conversation in real-time chat 212, but may require an additional step to convert voice communications in real-time chat 212 to text using a speech-to-text machine learning model (or, by using other equivalent methods). In embodiments where video chat is occurring between user(s) 223, chatbot 225, etc., another step may be required where the video is analyzed using a machine learning model and a plain text description (or other description) is generated indicating a script of the video, description of action, description of background, description of the actors, etc., for further utilization. Various embodiments are contemplated as within the scope of the invention: by another example, in various embodiments of the invention, real-time chat analyzer 243 uses one or more of techniques in accessing and analyzing real-time chat 212, including natural language processing or linguistic and probabilistic methods (such as, by non-limiting example, topic modeling, corpus linguistics, reduce word vector integers, and model probabilistic co-occurrence).

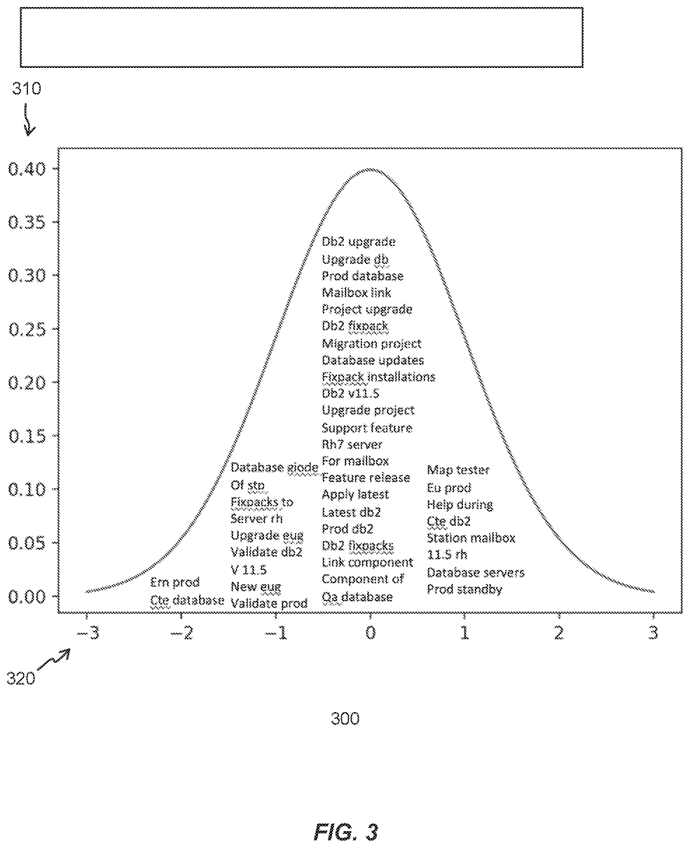

Word density function modeler 245 represents software and/or hardware to, in conjunction with real-time chat analyzer 243, to generate a word density function model (such as displayed in connection with FIG. 3) modeling at least part of the real-time chat 212. As discussed above, real-time chat analyzer 243 uses in various embodiments various techniques in analyzing real-time chat 243, depending on the nature of the communications and otherwise. After real-time chat analyzer 243 accesses and analyzes the real-time chat 212, based upon the analysis provided by real-time chat analyzer 243, word density function modeler generates a word density function model which models at least a part of the real-time chat 212 (or the entire real-time chat 212). In the example of where a user 223 presents a question in real-time chat 212 to another user 223 or chatbot 225, after real-time chat analyzer 243 analyzes the question, word density function modeler 245 generates a word density function model representing the analysis of the question. In cases where the user 223 discusses another topic in real-time chat 212, word density function modeler 245 generates an appropriate word density function model representing all or part of the real-time chat 212. In an embodiment of the invention, the word density function model is associated with an array of integers which maps a co-occurrence of related terms which occur in the real-time chat 212. In further or alternative embodiments of the invention, the word density model is associated with selectively one or more of a topic bundle likelihood, a term frequency, a bigram count, a trigram count, a probability density function, and a scale of a probability density function.

Public chat channel analyzer 247 represents software and/or hardware for accessing one or more persistent conversations held in public chat channel(s) 214. In various embodiments of the invention, public chat channel(s) 214, as discussed otherwise herein, offer persistent communications between any number of user(s) 223 in the form of text chat, voice chat, video chat, image chat, multimedia chat, etc. Public chat analyzer 247 accesses the one or more public chat channel(s) 214 and utilizes, in various embodiments, the word density function model provided by word density function modeler 245 and/or other analysis techniques provided by real-time chat analyzer 243 in order to determine one or more persistent chats in the public chat channel(s) 214 which are similar to the current conversation held between user(s) 223 and/or chatbot (225). In various embodiments of the invention, public chat channel analyzer 247 then also provides a location of the relevant information in the public chat channel(s) 214, such as in a certain window, a certain part of a scrolling graphical user interface, etc., and the window is automatically presented, the graphical user interface automatically scrolls to the relevant section, etc. in order for user 223 to quickly view that section of public chat channel(s) 214.

Computer messaging software access module 249 represents software and/or hardware to facilitation communications between computer messaging software 210 and computer messaging software analyzer 240, in order to perform various functionality in connection with embodiments disclosed herein. For example, computer messaging software access module 249 provides functionality for real-time chat analyzer 243 of computer messaging software analyzer 240 to access real-time chat 212, and, for example, for public chat channel analyzer 247 to access public chat channel(s) 214, as further discussed herein. Other communications functionality between computer messaging software analyzer 240 and computer messaging software 210 are contemplated by embodiments of the invention.

FIG. 3 is a graphical representation of a word density function model 300, in accordance with an embodiment of the present invention. In various embodiments of the invention, word density function model 300 is generated by word density function modeler 245, such as displayed in connection with FIG. 2. Word density function model 300 shows along y-axis 310 a relative prevalence of various terms, and along x-axis 320 the terms themselves which have been located in real-time chat 212. As is discussed further herein, the word density function model 300 is used in a determination of one or more similar public chat channel(s) 214, as further discussed herein.

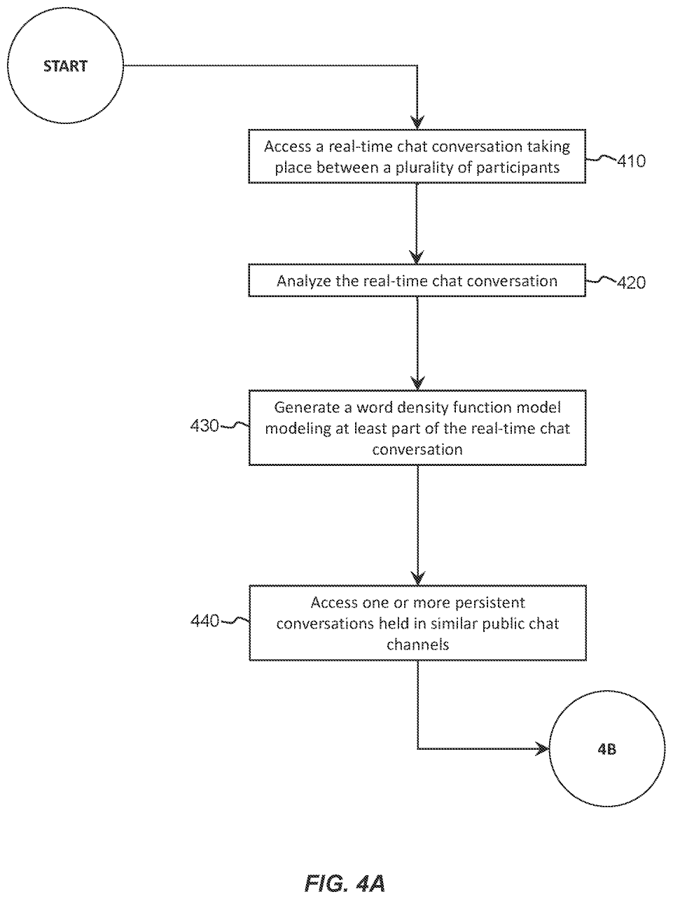

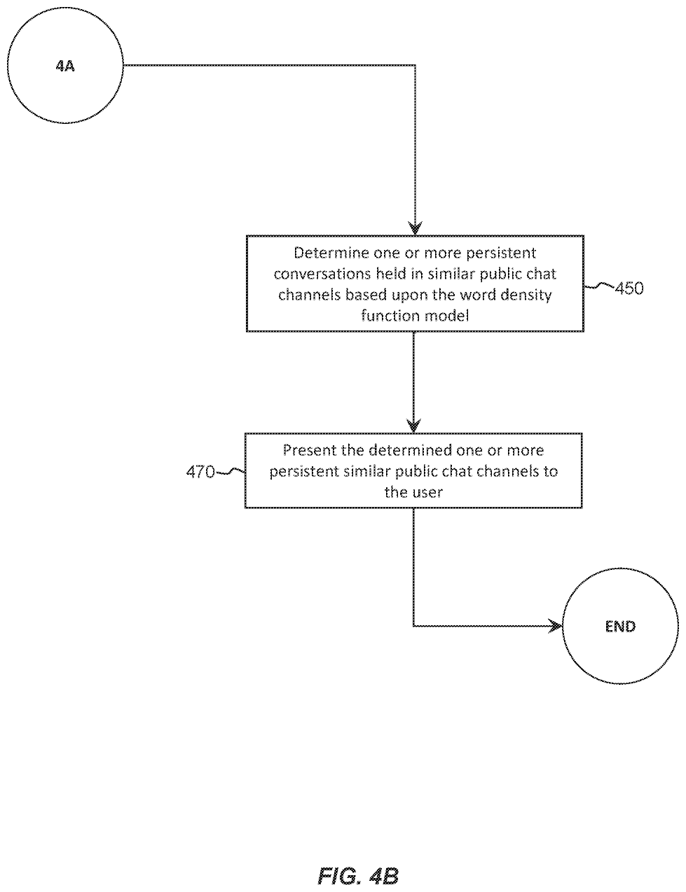

FIGS. 4A and 4B are a flowchart depicting operational steps that a hardware component, multiple hardware components, and/or a hardware appliance may execute, in accordance with an embodiment of the invention. As shown in FIG. 4A, at step 410 a computing device accesses a real-time chat 212 taking place between a plurality of participants. At step 420, the computing device analyzes the real-time chat 212. At step 430, the computing device generates a word density function model 300 modeling at least a part of the real-time chat 212. At step 440, the computing device accesses one or more persistent conversations held in a plurality of public chat channel(s) 214.

Continuing in FIG. 4B, at step 450, the computing device determines one or more persistent conversations held in similar public chat channel(s) 214 based upon the word density function model 300. At step 460, the computing device presents the determined one or more persistent similar public chat channel(s) 214 to the user, allowing the user to quickly peruse relevant information

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using computing device to determine a similarity between a chat conversation and one or more other chat conversations in public chat channels within computer messaging software and automatically presenting the similar public chat channels to a user, the method comprising:
accessing by a computing device a real-time chat conversation, the chat conversation taking place between a plurality of participants;
analyzing by the computing device the real-time chat conversation to generate a word density function model modeling at least a part of the real-time chat conversation;
accessing by the computing device one or more persistent conversations held in a plurality of public chat channels;
determining by the computing device one or more persistent conversations held in similar public chat channels based upon the generated word density function model; and
presenting by the computing device the determined one or more persistent similar public chat channels to a user.

2. The method of claim 1, wherein the real-time chat conversation includes a question from a participant of the plurality of participants.

3. The method of claim 2, wherein the word density function model represents an analysis of the question from the participant.

4. The method of claim 3, wherein the determined one or more similar public channels present a similar question and an answer to the similar question.

5. The method of claim 4, wherein the computing device automatically redirects the user to the location in the one or more persistent similar public chat channels to find the similar question and the answer to the similar question.

6. The method of claim 5, wherein the one or more persistent similar public chat channels are located in a graphical user interface and the graphical user interface automatically scrolls to the location to find the similar question and the answer to the similar question.

7. The method of claim 1, wherein analyzing by the computing device the real-time chat conversation to generate the word density function model involves selectively one or more of the following: topic modeling, corpus linguistics, reduce word vectors integer, and model probabilistic co-occurrence.

8. The method of claim 1, wherein the word density function model is associated with an array of integers which maps a co-occurrence of related terms in the real-time chat conversation.

9. The method of claim 1, wherein the word density function model is associated with selectively one or more of the following: a topic bundle likelihood, a term frequency, a bigram count, a trigram count, a probability density function, a shape of a probability density function, and a scale of a probability density function.

10. The method of claim 1, wherein one or more of the plurality of participants in the real-time chat conversation is an artificial intelligence chatbot.

11. The method of claim 1, wherein the real-time chat conversation occurs in a direct message between users.

12. The method of claim 1, wherein the real-time chat conversation occurs in a first public chat channel the plurality of participants are part of.

13. The method of claim 1, wherein the real-time chat conversation comprises selectively one or more of the following: a text chat, a voice chat, and images.

14. A computer program product using a computing device to determine a similarity between a chat conversation and one or more other chat conversations in public chat channels within computer messaging software and automatically presenting the similar public chat channels to the user, the computer program product comprising:
one or more non-transitory computer-readable storage media and program instructions stored on the one or more non-transitory computer-readable storage media, the program instructions, when executed by the computing device, cause the computing device to perform a method comprising:
accessing by a computing device a real-time chat conversation, the chat conversation taking place between a plurality of participants;
analyzing by the computing device the real-time chat conversation to generate a word density function model modeling at least a part of the real-time chat conversation;
accessing by the computing device one or more persistent conversations held in a plurality of public chat channels;
determining by the computing device one or more persistent conversations held in similar public chat channels based upon the generated word density function model; and
presenting by the computing device the determined one or more persistent similar public chat channels to a user.

15. The computer program product of claim 14, wherein the real-time chat conversation includes a question from a participant of the plurality of participants.

16. The computer program product of claim 15, wherein the word density function model represents an analysis of the question from the participant.

17. The computer program product of claim 16, wherein the determined one or more similar public channels present a similar question and an answer to the similar question.

18. A computer system for a determination of similarity between a chat conversation and one or more other chat conversations in public chat channels within computer messaging software and automatically presenting the similar public chat channels to a user, the computer system comprising:
one or more computer processors;
one or more computer-readable storage media;
program instructions stored on the computer-readable storage media for execution by at least one of the one or more processors, the program instructions comprising:
program instructions to access by a computing device a real-time chat conversation, the chat conversation taking place between a plurality of participants;
program instructions to analyze by the computing device the real-time chat conversation to generate a word density function model modeling at least a part of the real-time chat conversation;
program instructions to access by the computing device one or more persistent conversations held in a plurality of public chat channels;
program instructions to determine by the computing device one or more persistent conversations held in similar public chat channels based upon the generated word density function model; and
program instructions to present by the computing device the determined one or more persistent similar public chat channels to a user.

19. The computer system of claim 18, wherein the one or more persistent similar chat channels are located in a graphical user interface and the graphical user interface automatically scrolls to the location to find the similar question and the answer to the similar question.

20. The computer system of claim 18, wherein the word density function model is associated with an array of integers which maps a co-occurrence of related terms in the real-time chat conversation.
